(19) United States
(12) Patent Application Publication
(10) Pub. No.: US 2007/0281544 A1
(43) Pub. Date: Dec. 6, 2007

(54) Terminal device for miniature motor

(75) Inventor: Wan-Shun Chou, Taipei (TW)

Correspondence Address: BIRCH STEWART KOLASCH & BIRCH, PO BOX 747, FALLS CHURCH, VA, 22040-0747, US

(73) Assignee: I-CHIUN PRECISION INDUSTRY CO., LTD.

(21) Appl. No.: 11/806,932

(22) Filed: Jun. 5, 2007

(30) Foreign Application Priority Data
Jun. 6, 2006 (TW) 095209805

(51) Int. Cl. H01R 13/40

(52) U.S. Cl. 439/595

(57) ABSTRACT

The invention discloses a terminal device fixed on a miniature motor and used for connecting with a circuit board. The terminal device includes a fixing portion, an arc portion, a contact portion, and a ground portion. The terminal device is fixed on the miniature motor by the fixing portion. The arc portion protrudes from the fixing portion, and the connection between the arc portion and the fixing portion acts as a first fulcrum. The contact portion bends and protrudes from the arc portion, and the contact portion is capable of being operated to contact the arc portion, so as to provide a second fulcrum. The ground portion protrudes from the contact portion and is used for connecting with the circuit board.

### BACKGROUND OF THE INVENTION

1. Field of the Invention

The invention relates to a terminal device for a miniature motor.

2. Description of the Prior Art

A miniature motor is referred to as one with a size smaller than 5φ in the industry; namely the diameter of the miniature motor is less than 5 mm. The starting current and load current of the miniature motor are different from a small motor for several tens mA, or even smaller. The size of the small motor is generally larger than 5φ, or even larger than 10φ, and the starting current and the load current of the small motor are several hundreds mA.

Referring to FIG. 1 and FIG. 2, FIG. 1 is a side view of a motor 1 of the prior art. FIG. 2 is an external view of a terminal 8 shown in FIG. 1. As shown in FIG. 1, the motor 1 comprises a motor body A, a motor case 2, an output shaft 3, a contact 4, a bracket 5, a weight 6, a circuit board 7, a terminal 8, a holder 16, and a leg 17. The terminal 8 is capable of allowing the contact 4 and its corresponding predetermined electric contacts in the circuit board 7 to electrically connect with each other upon a single motion. The terminal 8 is secured to the contact 4 with solder S.

The terminal 8 is formed by bending a thin spring. As shown in FIG. 2, the terminal 8 has an attachment 10 secured to the contact 4 of the motor body A by the solder S. The terminal 8 has a first portion 11 bent inward (toward the weight 6) at right angles at the lower end of the attachment 10. The first portion 11 extends substantially parallel to the output shaft 3 along the peripheral of the motor case 2. The terminal 8 also has a second portion 12 which extends substantially parallel to the first portion 11 by the way of a bent part B at which the front end of the first portion 11 is bent into a U-shape. The terminal 8 has a third portion 13 which is bent so as to project outward from the rear end of the second portion 12. The rear end of the third portion 13 is formed with a curved part 13a which has a top area formed with a ground portion 14 whose surface is plated with Au. The ground portion 14 ensures electrical connection between the terminal 8 and its corresponding predetermined electrical contact in the circuit board 7.

However, because the terminal 8 is bended toward the first portion 11 by the third portion 13, the elastic force resulted from bending is mainly generated by the bent part B formed at the front end of the first portion 11. When the circuit board 7 is pressed down, the resilience of the bent part B of the terminal 8 will get worse and will influence the tightness of contact between the ground portion 14 and the circuit board 7, thus also decreasing the transmission efficiency of current.

Additionally, because the terminal 8 vibrates with the motor case 2 constantly, it easily causes elastic fatigue and even deformation if the terminal 8 if it is only supported by the bent part B.

Therefore, it is necessary to design a new terminal device for the miniature motor to overcome the aforesaid problems.

### SUMMARY OF THE INVENTION

A scope of the invention is to provide a terminal device capable of increasing resilience force efficiently to enhance the tightness of contact between the terminal device and a circuit board.

Another scope of the invention is to provide a terminal device capable of preventing elastic fatique or deformation.

According to a preferred embodiment, a terminal device of the invention is fixed on the main body of the miniature motor and is used for connecting with a circuit board. The terminal device comprises a fixing portion, an arc portion, a contact portion, and a ground portion. The terminal device is fixed on the main body of the miniature motor by the fixing portion. The arc portion protrudes from the fixing portion, and a connection between the arc portion and the fixing portion acts as a first fulcrum. The contact portion bends and protrudes from the arc portion. The contact portion is capable of being operated to contact the arc portion, so as to provide a second fulcrum. The ground portion protrudes from the contact portion and is used for connecting with the circuit board.

In the aforesaid embodiment, when the ground portion of the terminal device is pressed down by an external force, the external force is evenly distributed over the arc portion via the second fulcrum. Additionally, when the external force is applied to the arc portion via the second fulcrum, the arc portion extends along a direction parallel to an output shaft of the miniature motor. Accordingly, the resilience force is increased efficiently to increase the tightness of contact between the terminal device and the circuit board, so as to enhance the transmission efficiency of current. Moreover, because the terminal device of the invention utilizes the first and second fulcrums to be elastic support, the probability of generating elastic fatigue or deformation can be reduced effectively.

The advantage and spirit of the invention may be understood by the following recitations together with the appended drawings.

### BRIEF DESCRIPTION OF THE APPENDED DRAWINGS

FIG. 1 is a side view of a motor in the prior art.

FIG. 2 is an external view of a terminal shown in FIG. 1.

FIG. 3 is a side view of a miniature motor and a terminal device of the invention.

FIG. 4 is an external view of the terminal device shown in FIG. 3.

FIG. 5 is a schematic diagram of the terminal device shown in FIG. 4 pressed by an external force.

FIG. 6 is a side view of a terminal device according to another preferred embodiment of the invention.

FIG. 7 is a side view of a terminal device according to another preferred embodiment of the invention.

FIG. 8 is a side view of a terminal device according to another preferred embodiment of the invention.

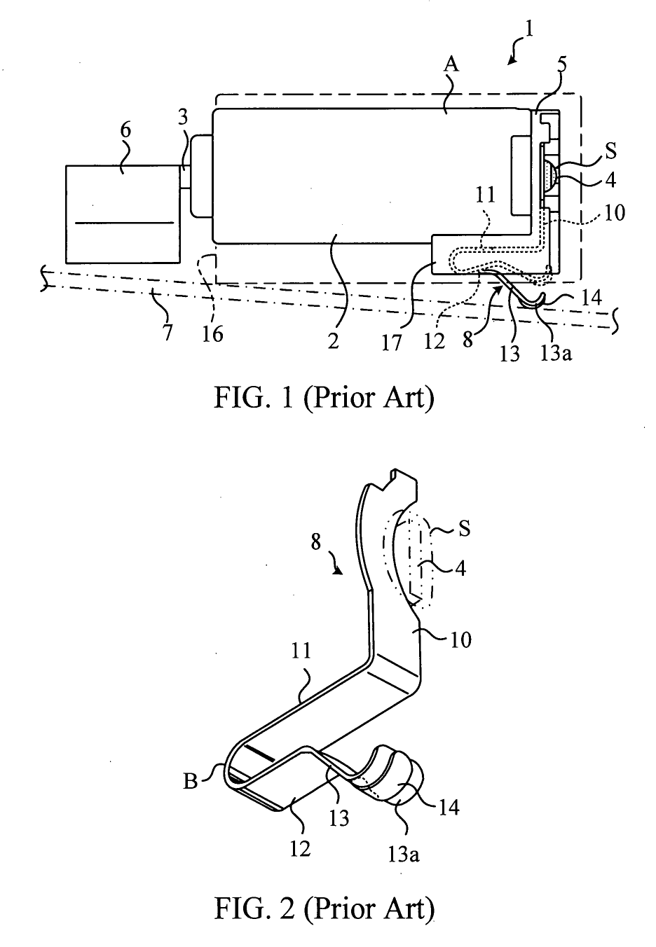

### DETAILED DESCRIPTION OF THE INVENTION

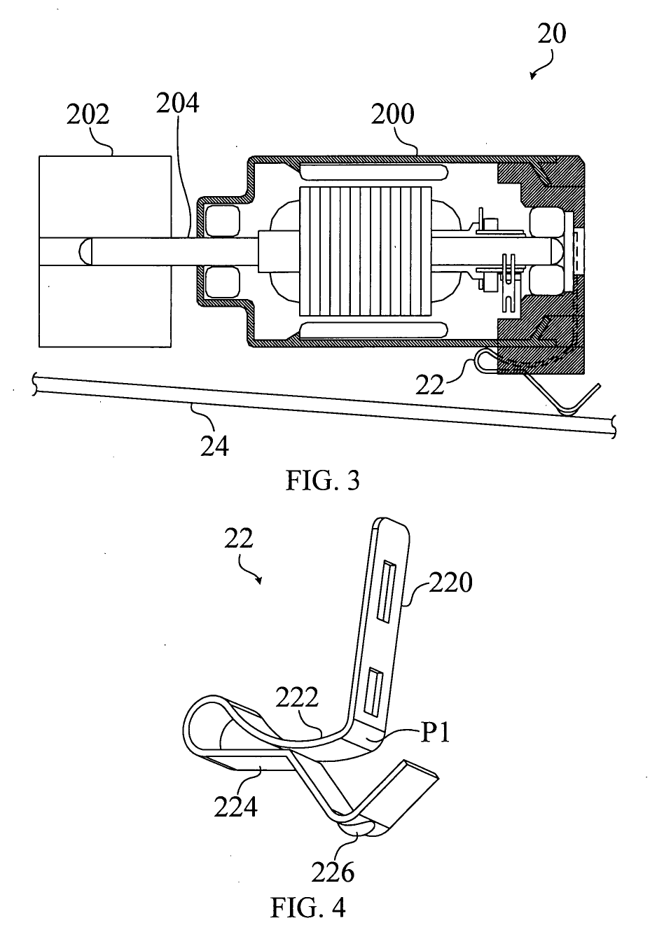

Referring to FIG. 3 and FIG. 4, FIG. 3 is a side view of a miniature motor 20 and a terminal device 22 of the invention. FIG. 4 is an external view of the terminal device 22 shown in the FIG. 3. As shown in FIG. 3, the terminal device 22 is used for the miniature motor 20. The miniature motor 20 has a main body 200, a weight 202, and an output shaft 204. The terminal device 22 is fixed on the main body 200 of the miniature motor 20 and used for connecting with a circuit board 24. The terminal device 22 is made of copper or the like and is selectively covered by nickel, palladium, and gold.

As shown in FIG. 4, the terminal device 22 comprises a fixing portion 220, an arc portion 222, a contact portion 224, and a ground portion 226. The terminal device 22 is fixed on the main body 200 of the miniature motor 20 by the fixing portion 220. The arc portion 222 protrudes from the fixing portion 220, and a connection between the arc portion 222 and the fixing portion 220 acts as a first fulcrum P1. The contact portion 224 bends and protrudes from the arc portion 222. The ground portion 226 protrudes from the contact portion 224 and is used for connecting with the circuit board 24 (as shown in FIG. 3).

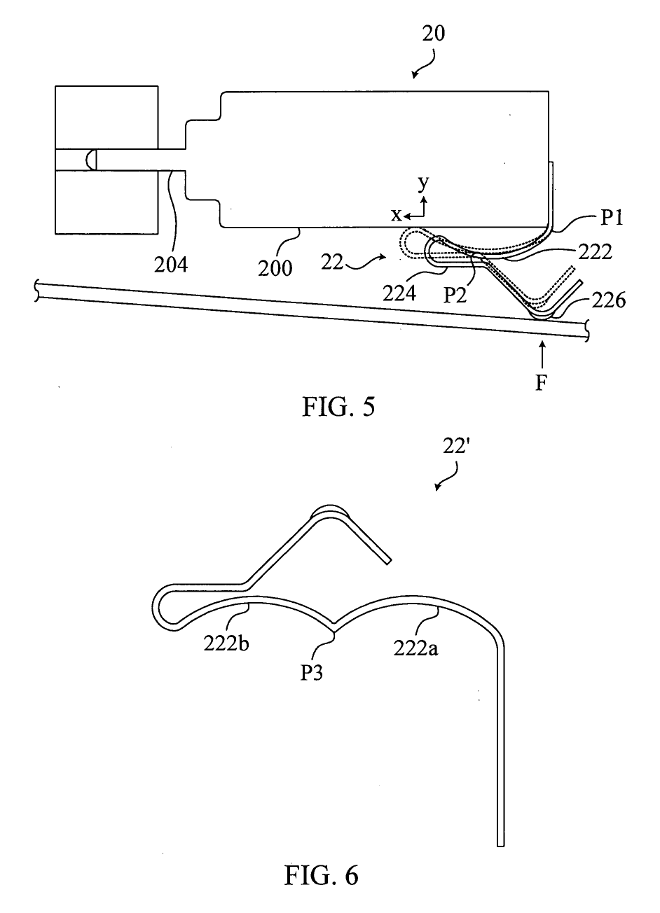

Referring to FIG. 5, FIG. 5 is a schematic diagram of the terminal device 22 shown in FIG. 4 pressed by an external force F. When the ground portion 226 of the terminal portion 22 is pressed down by the external force F, the contact portion 224 is capable of being operated to contact the arc portion 222, so as to provide a second fulcrum P2. Then, the external force F will be evenly distributed over the arc portion 222 via the second fulcrum P2. Additionally, when the external force F is applied to the arc portion 222 via the second fulcrum P2, the arc portion 222 extends along a direction parallel to the output shaft 204 of the miniature motor 20, as the direction of an arrow x shown in FIG. 5. In this embodiment, when the external force F is applied to the arc portion 222 via the second fulcrum P2, the arc portion 222 uses the first fulcrum P1 as a rotating axis to move along a direction perpendicular to the output shaft 204 of the miniature motor 20, as the direction of an arrow y shown in the FIG. 5. It should be noted that if the front end of the arc portion 222 has contacted the main body 200 of the miniature motor 20 before the external force F acts on the front end of the arc portion 222, the arc portion 222 only extends along the direction parallel to the output shaft 204 when the terminal device 22 is pressed down by the external force F, depending on practical applications. Additionally, before being pressed by the external force F, the contact portion 224 of the terminal device 22 also can be designed to contact the arc portion 222, depending on practical applications.

Referring to FIG. 6, FIG. 6 is a side view of a terminal device 22′ according to another preferred embodiment of the invention. The main difference between the terminal device 22′ and the terminal device 22 is that the terminal device 22′ comprises two arc portions 222a and 222b. The connection between the arc portions 222a and 222b is regarded as a third fulcrum P3. By this configuration, the designs of the terminal device 22′ will be able to provide more variations of application. The principles and functions of the terminal device 22′ shown in FIG. 6 are the same with those of the terminal device 22 shown in FIG. 3, and the related description is not described here.

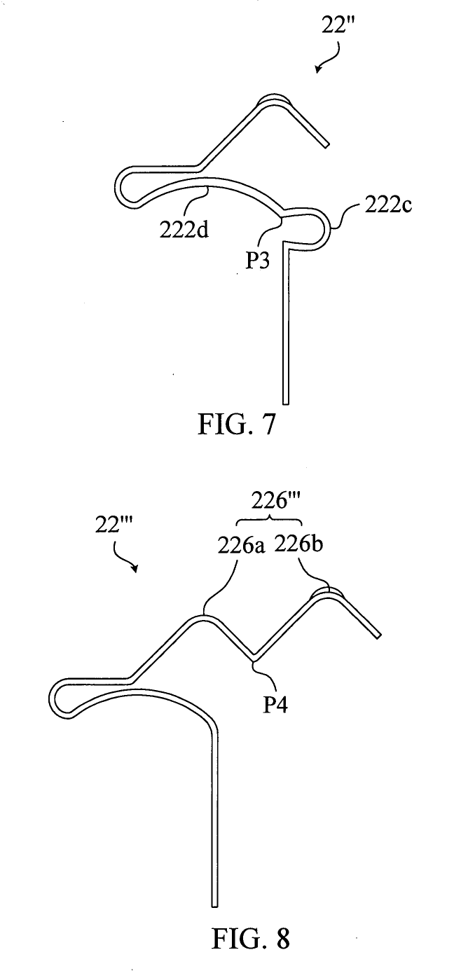

Referring to FIG. 7, FIG. 7 is a side view of a terminal device 22″ according to another preferred embodiment of the invention. The main difference between the terminal device 22″ and the terminal device 22 is that the terminal device 22″ comprises two arc portions 222c and 222d. The connection between the arc portions 222c and 222d is regarded as a third fulcrum P3. By this configuration, the designs of the terminal device 22″ will be able to provide more variations of application. The principles and functions of the terminal device 22″ shown in FIG. 7 are the same with those of the terminal device 22 shown in FIG. 3, and the related description is not described here.

Referring to FIG. 8, FIG. 8 is a side view of a terminal device 22′″ according to another preferred embodiment of the invention. The main difference between the terminal device 22′″ and the terminal device 22 is that the ground portion 226′″ of the terminal device 22′″ comprises two bent parts 226a and 226b, and the connection between the bent parts 226a and 226b is regarded as a fourth fulcrum P4. By this configuration, the designs of the terminal device 22′″ will be able to provide more variations of application. The principles and functions of the terminal device 22′″ shown in FIG. 8 are the same with those of the terminal device 22 shown in FIG. 3, and the related description is not described here.

Compared to the prior art, the terminal device of the invention is capable of increasing resilience force efficiently by the design of the arc portion, so as to increase the tightness of contact between the terminal device and the circuit board to enhance the transmission efficiency of current. Additionally, because the terminal device utilizes the first, second, third, and/or fourth fulcrums to be elastic support, the probability of generating elastic fatigue or deformation can be reduced effectively.

With the example and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

What is claimed is:

1. A terminal device for a miniature motor, the miniature motor having a main body, the terminal device being fixed on the main body and used for connecting with a circuit board, the terminal device comprising:
a fixing portion, the terminal device being fixed on the main body of the miniature motor by the fixing portion;
at least one arc portion, protruding from the fixing portion, a connection between the at least one arc portion and the fixing portion acting as a first fulcrum;
a contact portion, bending and protruding from the at least one arc portion, the contact portion being capable of being operated to contact the at least one arc portion, so as to provide a second fulcrum; and
a ground portion, protruding from the contact portion and being used for connecting with the circuit board.

2. The terminal device of claim 1, wherein a connection between each of the arc portions acts as a third fulcrum.

3. The terminal device of claim 1, wherein the ground portion comprises at least one bending portion, and a connection between each of the bending portions acts as a fourth fulcrum.

4. The terminal device of claim 1, wherein when the ground portion of the terminal device is pressed down by an external force, the external force is evenly distributed over the arc portion via the second fulcrum.

5. The terminal device of claim 4, wherein when the external force is applied to the arc portion via the second fulcrum, the arc portion extends along a direction parallel to an output shaft of the miniature motor.

6. The terminal device of claim 4, wherein when the external force is applied to the arc portion via the second fulcrum, the arc portion moves along a direction perpendicular to an output shaft of the miniature motor.

7. The terminal device of claim 1, wherein the terminal device is made of copper and covered by nickel, palladium, and gold.
